(19) United States
(12) Patent Application Publication
(10) Pub. No.: US 2024/0424655 A1
(43) Pub. Date: Dec. 26, 2024

(54) Systems and Methods for Multi-Channel Power Tool Communication

(71) Applicant: Milwaukee Electric Tool Corporation, Brookfield, WI (US)

(72) Inventors: Anthony M. Davis, Brookfield, WI (US); Jeremy R. Ebner, East Troy, WI (US); Stephen E. Matson, Milwaukee, WI (US)

(21) Appl. No.: 18/690,012

(22) PCT Filed: Sep. 9, 2022
(86) PCT No.: PCT/US2022/043115

§ 371 Date: Mar. 7, 2024

Related U.S. Application Data
(60) Provisional application No. 63/242,731, filed on Sep. 10, 2021.

(51) Int. Cl. B25F 5/00; H04W 92/10

(52) U.S. Cl. CPC B25F 5/00; H04W 92/10

(57) ABSTRACT

A system and method for power tool communication is provided. In particular, a gateway device communicates in parallel with a plurality of power tools. The gateway device may establish communication links with a plurality of power tools, each communication link associated with a power tool, with a transceiver-converter pair of a plurality of transceiver-converter pairs, and with a frequency channel of a plurality of frequency channels. The gateway device may further communicate with each of the power tools in parallel over the communication links, wherein the communication with each respective power tool of the plurality of power tools occurs with the transceiver-converter pair and frequency channel associated with the respective power tool. In some examples, the gateway device establishes a link and communicates with the plurality of power tools using a shared transceiver-converter pair.

### RELATED APPLICATIONS

The present application is based on and claims priority from U.S. Patent Application No. 63/242,731, filed on Sep. 10, 2021, the entire disclosure of which is incorporated herein by reference.

### BACKGROUND

Work tools (e.g., power tools) allow operators to implement various functionalities on many different components (e.g., electrical wires, power cables, sheet metal, etc.). For example, some cutting tools can include a cutting head that is driven (e.g., hydraulically, or electrically) into a component, such as a power wire, to cut through the component.

### SUMMARY

Some embodiments of the disclosure provide a gateway device for communication with power tool devices. The gateway device can include a communications interface including transceiver-converter pairs, the transceiver-converter pair including a transceiver coupled to a signal converter. The gateway device can further include an electronic controller coupled to the communications interface and including a processor. The electronic controller can be configured to sequentially scan, via the communication interface, through a plurality of frequency channels, each frequency channel associated with a power tool device of a plurality of power tool devices. Additionally, the electronic controller can be configured to communicate, via the communication interface, with each of the power tool devices of the plurality of power tool devices. The communication with each respective power tool device of the plurality of power tool devices can occur with the frequency channel associated with the respective power tool device and with the transceiver-converter pair.

Some embodiments of the disclosure provide a gateway device for parallel communication with power tool devices. The gateway device can include a communications interface including a plurality of transceiver-converter pairs, each transceiver-converter pair including a transceiver coupled to a signal converter. The gateway device can further include an electronic controller coupled to the communications interface and including a processor. The electronic controller can be configured to establish, via the communication interface, communication links with a plurality of power tool devices, each communication link associated with a power tool device of the plurality of power tool devices, with a transceiver-converter pair of the plurality of transceiver-converter pairs, and with a frequency channel of a plurality of frequency channels. The electronic controller can be further configured to communicate, via the communication interface, with each of the power tool devices of the plurality of power tool devices in parallel over the communication links. The communication with each respective power tool device of the plurality of power tool devices can occur with the transceiver-converter pair and frequency channel associated with the respective power tool device.

Some embodiments of the disclosure provide a gateway device for parallel communication with power tool devices. The gateway device can include a communications interface including a transceiver-converter pair, the transceiver-converter pair including a transceiver coupled to a signal converter. The gateway device can further include an electronic controller coupled to the communications interface and including a processor. The electronic controller can be configured to establish, via the communication interface, communication links with a plurality of power tool devices, each communication link associated with a power tool device of the plurality of power tool devices and with a frequency channel of a plurality of frequency channels. Additionally, the electronic controller can be configured to communicate, via the communication interface, with each of the power tool devices of the plurality of power tool devices in parallel over the communication links using the transceiver-converter pair. The communication with each respective power tool device of the plurality of power tool devices can occur with the frequency channel associated with the respective power tool device.

Some embodiments of the present disclosure provide a method for communication with power tool devices. The method can include sequentially scanning, via a communication interface, through a plurality of frequency channels, each frequency channel associated with a power tool device of a plurality of power tool devices. The method can further include communicating, via the communication interface, with each of the power tool devices of the plurality of power tool devices, wherein the communication with each respective power tool device of the plurality of power tool devices occurs with the frequency channel associated with the respective power tool device and with the transceiver-converter pair.

Some embodiments of the present disclosure provide a method for parallel communication with power tool devices. The method can include establishing, via a communication interface, communication links with a plurality of power tool devices, each communication link associated with a power tool device of the plurality of power tool devices, with a transceiver-converter pair of a plurality of transceiver-converter pairs of the communication interface, and with a frequency channel of a plurality of frequency channels. The method can further include communicating, via the communication interface, with each of the power tool devices of the plurality of power tool devices in parallel over the communication links, wherein the communication with each respective power tool device of the plurality of power tool devices occurs with the transceiver-converter pair and frequency channel associated with the respective power tool device.

Some embodiments of the present disclosure provide a method for parallel communication with power tool devices. The method can include establishing, via a communication interface, communication links with a plurality of power tool devices, each communication link associated with a power tool device of the plurality of power tool devices and with a frequency channel of a plurality of frequency channels. The method can further include communicating, via the communication interface, with each of the power tool devices of the plurality of power tool devices in parallel over the communication links using the transceiver-converter pair, wherein the communication with each respective power tool device of the plurality of power tool devices occurs with the frequency channel associated with the respective power tool device.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 is a schematic illustration of a power tool system, in accordance with embodiments of the present disclosure.

FIG. 2 is a block diagram of a power tool associated with the power tool system of FIG. 1, in accordance with embodiments of the present disclosure.

FIG. 3 is a block diagram of a gateway device associated with the power tool system of FIG. 1, in accordance with embodiments of the present disclosure.

FIG. 4 is a block diagram of a system for serial power tool communication, in accordance with embodiments of the present disclosure.

FIG. 5 is a flowchart of a process for power tool communication, in accordance with embodiments of the present disclosure.

FIG. 6 is a block diagram of a system for parallel power tool communication, in accordance with embodiments of the present disclosure.

FIG. 7 is a flowchart of a process for parallel power tool communication, in accordance with embodiments of the present disclosure.

FIG. 8 is a block diagram of another system for parallel power tool communication, in accordance with embodiments of the present disclosure.

FIG. 9 is a flowchart of another process for parallel power tool communication, in accordance with embodiments of the present disclosure.

### DETAILED DESCRIPTION

As described above, power tools generally can implement various functionalities on different components. For example, power tools generally can include an actuator including a moveable component that when moved into contact with the component, implements some kind of functionality on the component. For example, when the power tool is implemented as a cutting tool, the actuator of the cutting tool can include a cutting head that can, when moved into contact with a work piece (e.g., a wire to be cut) sever the work piece in two. As another example, when the power tool is implemented as a crimping tool, the actuator of the crimping tool can include a crimping head that can, when moved into contact with a work piece (e.g., a wire to be crimped), crimp the work piece (e.g., to create an electrical connection to the wire). As another example, when the power tool is a drill-driver, the actuator of the power tool may be a drill chuck configured to accept and retain a drill or driver bit and that is driven by the power tool to rotate the retained bit to, for example, drill a hole in a workpiece (in the case of a drill bit) or drive a fastener into a workpiece (in the case of a drive bit).

Some power tools can include an electronic controller that can control various features of the tool. For example, the electronic controller can drive extension (or rotation or oscillation) of the actuator to implement a functionality on a work piece, or can drive retraction (or rotation in the opposing direction) of the actuator (e.g., after the functionality has been completed or to remove a fastener). In some embodiments, the electronic controller of the power tool can receive data from sensors of the power tool, which can augment the control of the actuator and/or be stored for later retrieval or export.

In some embodiments, each power tool of the presently disclosed power tool system can include one or more transceivers (e.g., as part of one or more Bluetooth® wireless modules) that are capable of communicating with other devices (e.g., other power tools or a gateway device) according to a Bluetooth® wireless protocol, which can have advantages as compared to other wireless protocols (e.g., using less power to communicate, providing fast communication speeds, ensuring one-to-one pairing between devices at some times, etc.).

In some embodiments, a gateway device can be in communication with each power tool, directly or via another power tool, using a first wireless communication protocol. The gateway device can receive power tool data from one or more power tools via this first wireless communication protocol. In some embodiments, the gateway device can further transmit the received power tool data over a network to a remote server (e.g., a cloud-based server) using a second communication protocol (e.g., cellular protocol or Wi-Fi®). The remote server can provide certain functions such as data analysis, summary, and storage. Accordingly, the gateway device generally serves as a bridge between the power tools and the remote server.

In some configurations, the gateway device can be configured to listen for messages (e.g., broadcast messages) from the power tools. Worksites often use a large number of power tools, each of which can be configured to send frequent beacon messages which are received by the gateway device. As an example, in a tool crib setting, many power tools can arrive and depart over a short period of time. It may be desirable to download data from all the present power tools quickly (e.g., receive data from a plurality of power tools), or alternatively, to update the firmware of the power tools (e.g., transmit data to a plurality of power tools). In certain circumstances, using Bluetooth® protocol can cause a delay in communication. In particular, Bluetooth® protocol is limited to operation in a one-to-many broadcast model, or a one-to-one bidirectional communication model. Accordingly, a single transceiver using Bluetooth® cannot easily handle simultaneous communications from multiple devices (e.g., multiple power tools at a worksite) or maintain simultaneous communication links with multiple devices.

Some embodiments described herein provide solutions to these problems (and others) by providing improved systems and methods for power tool communication. For example, some embodiments of the disclosure provide a power tool system that can include a plurality of power tools, each with a tool identification associated therewith, and a gateway device. The gateway device can be configured to transmit and/or receive data from a plurality of power tools over a plurality of communication channels and, in some examples, using parallel communication over these channels. The systems and methods described herein can facilitate simultaneous communications between the gateway device and a plurality of power tools or a gateway device that cycles between communication channels to more quickly communicate with a plurality of power tools. Advantageously, this can significantly decrease the amount of time needed for data transfer associated with a plurality of power tools.

These and other features of the present disclosure are discussed in greater detail below; and with respect to the accompanying Figures.

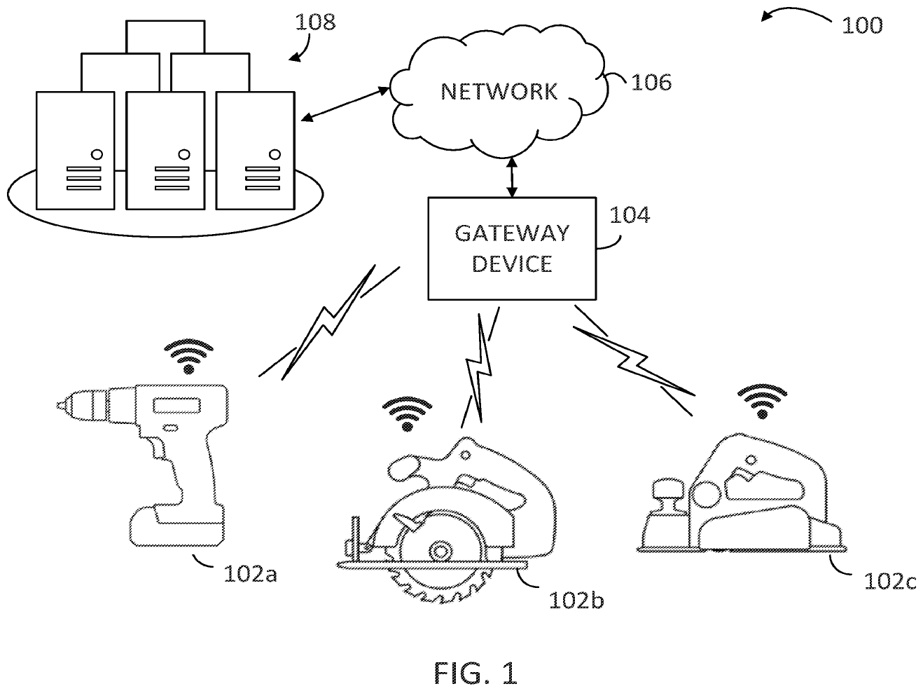

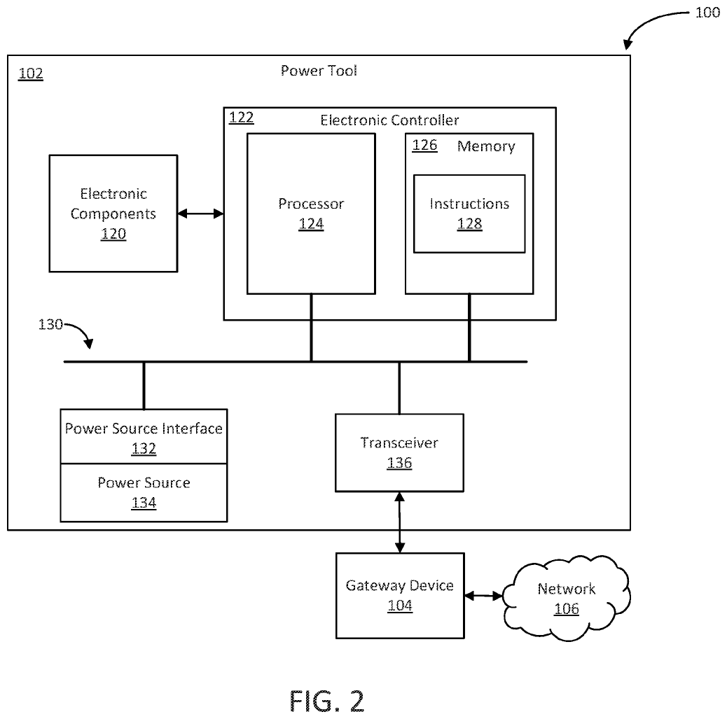

FIG. 1 shows a schematic illustration of a power tool system 100. The power tool system 100 can include one or more power tools (e.g., power tools 102a, 102b, 102c), a gateway device 104, a network 106, and a remote server 108. The power tools 102a, 102b, and 102c may be generically referred to as a power tool 102 (as also shown in FIG. 2) and collectively referred to as the power tools 102. As shown in FIG. 1, gateway device 104 can be configured to communicate directly with each power tool 102a, 102b, 102c. Further, the gateway device 104 can be configured to communicate with the remote server 108, via the network 106.

In some embodiments, the gateway device 104 can be implemented in different ways. For example, the gateway device 104 can include components such as a processor, memory, a display, inputs (e.g., a keyboard, a mouse, a graphical user interface, a touch-screen display, one or more actuatable buttons, etc.), communication devices (e.g., an antenna and appropriate corresponding circuitry), etc. In some embodiments, the gateway device 104 can simply be implemented as a processor. In some specific embodiments, the gateway device 104 can be implemented as a mobile phone (e.g., a smart phone), a personal digital assistant (“PDA”), a laptop, a notebook, a netbook computer, a tablet computing device, etc. In some embodiments, the gateway device 104 can include a power source (e.g., an AC power source, a DC power source, etc.), which can be in electrical communication with one or more power outlets (e.g., AC or DC outlets) and/or one or more charging ports (e.g., for charging a battery pack of a power tool). Thus, in some cases, the gateway device 104 can be a portable power supply and/or a charging device for one or more power tools. In some embodiments, the gateway device 104 can be implemented as a Wi-Fi® router, hub, or other access point.

Each power tool 102a, 102b, 102c may include an actuator, a power source (e.g., a battery pack), an electronic controller, a power source interface (e.g., a battery pack interface), etc. In some cases, each power tool 102a, 102b, 102c can be different (as representatively illustrated by FIG. 1), can be the same, etc. For example, one or more of the power tools 102a, 102b, 102c can be an impact driver, a power drill, a hammer drill, a pipe cutter, a sander, a nailer, a grease gun, a crimper, any other suitable tool that can be configured to transmit data, etc. Regardless of the configuration, each power tool 102a, 102b, 102c can be configured to directly communicate with each other (e.g., over a wireless communication channel), and/or with the gateway device 104. In some configurations, each power tool 102a, 102b, 102c can directly communicate with each other, and/or with the gateway device 104, according to a wireless communications protocol. As a non-limiting example, the protocol can be a Bluetooth®, Zigbee, or Wi-Fi® wireless protocol.

In some embodiments, each power tool 102a, 102b, 102c can include a tool identifier associated therewith, each of which uniquely identifies the respective power tool from other power tools. For example, the tool identifier can be a media access control (“MAC”) address, other unique identification information, etc. As another example, the tool identifier can be a user-friendly and/or user-defined name (e.g., identifying the type of power tool), such as Alice's nailer or Bob's impact driver.

As mentioned above, the power tool system 100 can include the network 106, and the remote server 108. Generally, the gateway device 104 can communicate with the remote server 108 via the network 106. More particularly, the gateway device 104 can communicate with an access point of the network 106 to communicate with the remote server 108 over the network 106. An access point can include, for example, a cellular tower or a router (e.g., a Wi-Fi® router).

The remote server 108 can store tool data for various power tools (e.g., the power tools of the power tool system 100) including configuration data for the power tools (e.g., to configure operational parameters of the power tool), usage data for the power tools (e.g., number of hours of available operation for a power tool), maintenance data for the power tools (e.g. a log of prior maintenance, suggestions for future maintenance, etc.), operator (and owner) information for the power tools, location data for the power tools (e.g., for inventory management and tracking), among other data. In some cases, power tools 102 of the power tool system 100 can periodically or occasionally attempt to communicate one or more types of tool data back to the remote server 108, or to otherwise communicate with the remote server 108 or access points of the power tool system 100.

The particular number, types, and locations of components with the power tool system 100 of FIG. 1 are merely used as an example for discussion purposes, and thus additional or different types of power tools, access points, networks, and servers can be present in other embodiments of the power tool system 100. As an example, the power tool system 100 can include one or more other wireless communication devices that can be in communication with the power tools of the power tool system 100, and/or the gateway device 104. In some cases, each of these wireless communication devices can include a power source, an antenna, a receiver, an electronic controller, etc., and each of these can be configured to communicate according to a Bluetooth®, Zigbee, Wi-Fi®, or another example of a wireless protocol.

Referring now to FIG. 2, a block diagram of an example power tool 102 within the power tool system 100 is shown, in accordance with embodiments of the present disclosure. The power tool 102 of FIG. 2 is representative of some examples of one or more of the power tools 102a, 102b, and 102c of FIG. 1. As shown, the power tool 102 can include electronic components 120, an electronic controller 122, a power source 134, and a transceiver 136. The electronic controller 122 can include a processor 124 and a memory 126. The processor 124, the memory 126, and the transceiver 136 can communicate over one or more control buses, data buses, etc., which can include a device communication bus 130. The memory 126 can include read-only memory (ROM), random access memory (RAM), other non-transitory computer-readable media, or a combination thereof. The memory 126 can include instructions 128 for the processor 124 to execute. The processor 124 can be configured to communicate with the memory 126 to store data and retrieve stored data. The processor 124 can be configured to receive the instructions 128 and data from the memory 126 and execute, among other things, the instructions 128. For example, the processor 124 may retrieve and execute the instructions 128 stored in the memory 126. Thus, at least through execution of the instructions 128, the electronic controller 122 can be configured to control or perform the various functions of the power tool 102 described herein.

The transceiver 136 can be communicatively coupled to the electronic controller 122. The transceiver 136 enables the electronic controller 122 (and, thus, the power tool 102) to communicate with other devices, such as a cellular tower, a Wi-Fi® router, a mobile device, other power tools, etc. In some examples, the transceiver 136 can further include a global navigation satellite system (GNSS) receiver configured to receive signals from GNSS satellites, land-based transmitters, etc. As shown by FIG. 2, the transceiver 136 can be configured to communicate (e.g., wirelessly) with the gateway device 104. In some examples, the transceiver 136 may include multiple transceivers, each associated with a particular communication protocol. Each such transceiver may include a driver circuit and an antenna. A driver circuit may receive signals to be transmitted from the electronic controller 122 over a wired connection and drives the antenna to transmit the signals as radio signals according to its associated communication protocol, and/or may receive radio signals from external devices via the antenna and provides the received signals to the electronic controller 122 via a wired connection. In some cases, two or more transceivers may share use of an antenna for transmitting and/or receiving radio signals.

In some embodiments, the power tool 102 also optionally includes a power source interface 132 that is configured to selectively receive and interface with a power source 134 (e.g., a battery). The power source interface 132 can include one or more power terminals and, in some cases, one or more communication terminals that interface with respective power terminals, communication terminals, etc., of the power source 134. The power source 134 can include a housing containing or supporting one or more battery cells selected from one of various chemistries, such as lithium-ion (Li-Ion), nickel cadmium (Ni-Cad), etc. The power source 134 can further selectively latch and unlatch (e.g., with a spring-biased latching mechanism) to the power tool 102 to prevent unintentional detachment. The power source 134 can further include a pack electronic controller (pack controller) including a processor and a memory. The pack controller can be configured similarly to the electronic controller 122 of the power tool 102. The pack controller can be configured to regulate charging and discharging of the battery cells, and/or to communicate with the electronic controller 122. In some embodiments, the power source 134 can further include a transceiver, similar to the transceiver 136, coupled to the pack controller via a bus similar to the device communication bus 130. Accordingly, the pack controller, and thus the power source 134, can be configured to communicate with other devices, such as the cellular tower, the Wi-Fi® router, the mobile device, or other power tools. In some embodiments, the memory of the pack controller can include instructions (e.g., the same or similar to the instructions 128). Accordingly, the power source 134 can effectively perform similarly to the power tool 102 in terms of communication within the system 100, periodically broadcasting pack information to the gateway device 104 (e.g., with a pack identifier, state of charge information, pack type, number of charges, number of discharges, etc.). The power source 134 can further include, for example, a charge level fuel gauge, analog front ends, sensors, etc.

The power source 134 can be coupled to and configured to power the various components of the power tool 102, such as the electronic controller 122, the transceiver 136, and the electronic components 120. However, to simplify the illustration, power line connections between the power source 134 and these components are not illustrated.

In some embodiments, the power tool 102 also optionally includes additional electronic components 120. For a motorized power tool (e.g., drill-driver, saw; etc.), the electronic components 120 can include, for example, an inverter bridge, a motor (e.g., brushed or brushless) for driving a tool implement, etc. For a non-motorized power tool (e.g., a work light, a work radio, ruggedized tracking device, a laser level, a laser distance measurer, battery pack chargers, portable power supplies, etc.), the electronic components 120 can include, for example, one or more of a lighting element (e.g., an LED, a laser, etc.), an audio element (e.g., a speaker), a sensor (e.g., a light sensor, ultrasound sensor, etc.), a power source, charging circuitry, power conversion circuitry, etc. In some examples, the gateway device 104 may be considered a particular example of a non-motorized power tool.

In some embodiments, the transceiver 136 can be within a separate housing along with the electronic controller 122 or another electronic controller, and that separate housing can selectively attach to the power tool 102. For example, the separate housing may attach to an outside surface of the power tool 102 or may be inserted into a receptacle of the power tool 102. Accordingly, the wireless communication capabilities of the power tool 102 can reside in part on a selectively attachable communication device, rather than integrated into the power tool 102. Such selectively attachable communication devices can include electrical terminals that engage with reciprocal electrical terminals of the power tool 102 to enable communication between the respective devices and enable the power tool 102 to provide power to the selectively attachable communication device. In other embodiments, the transceiver 136 can be integrated into the power tool 102.

The block diagram (and accompanying description) of FIG. 2 may also apply to some embodiments of the power source 134, except that, in a power tool battery pack implementation, the power source interface 132 and the power source 134 of the diagram can be replaced with a tool interface (e.g., to interface with a power source interface of a power tool). In the case of the power tool battery pack implementation, the electronic component 120 can include, for example, one or more battery cells, a charge level fuel gauge, analog front ends, sensors, etc.

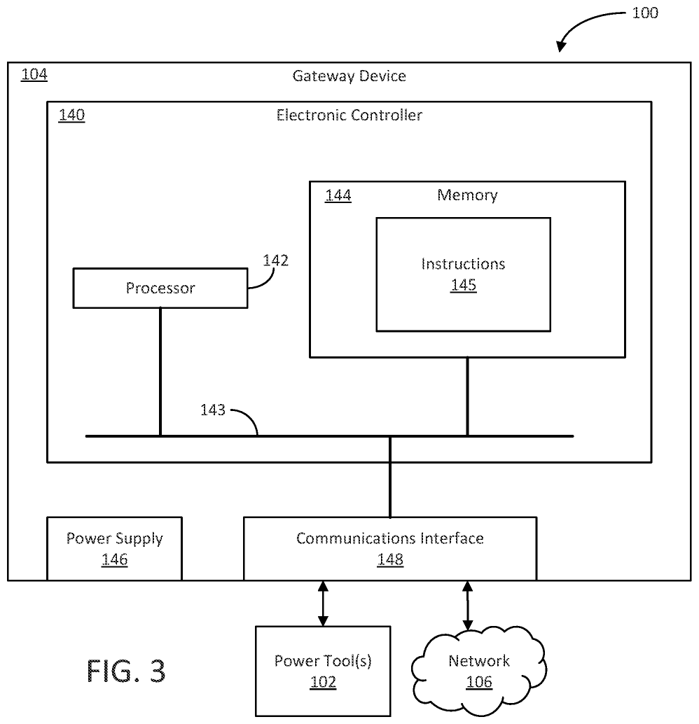

Referring now to FIG. 3, a block diagram illustrating the gateway device 104 in greater detail is shown, according to an example embodiment. The gateway device 104 can be located within a worksite and can be configured to communicate with the power tools(s) 102, and the network 106.

A communications interface 148 can include wired or wireless interfaces (e.g., jacks, antennas, transmitters, receivers, transceivers, wire terminals, etc.) for conducting electronic data communications with the power tools 102, the network 106, or other external systems or devices. Such communications can be direct (e.g., local wired or wireless communications) or via a communications network (e.g., a WAN, the Internet, a cellular network, etc.). For example, the communications interface 148 can include an Ethernet card and port for sending and receiving data via an Ethernet-based communications link or network. In some examples, the communications interface 148 can include one or more of a Wi-Fi® transceiver or a cellular or mobile phone communications transceiver for communicating via a wireless communications network. In some examples, the communications interface 148 can include one or more of a Bluetooth® transceiver, a Zigbee transceiver, or a Wi-Fi® transceiver for communicating with the power tools 102. The communications interface 148 can be communicably connected to the electronic controller 140 via a communication bus 143 such that the electronic controller 140 and the various components thereof can send and receive data via the communications interface 148.

In some embodiments, the gateway device 104 can include additional electronic components such as amplifiers, a display (e.g., an LCD display, a touch screen display), inputs (e.g., a keypad, a touch screen, a keyboard, a mouse, etc.), outputs, etc. In some embodiments, a power supply 146 (as shown by FIG. 3) can be a battery, an electrical cable (e.g., coupled to an AC wall outlet or other source), etc.

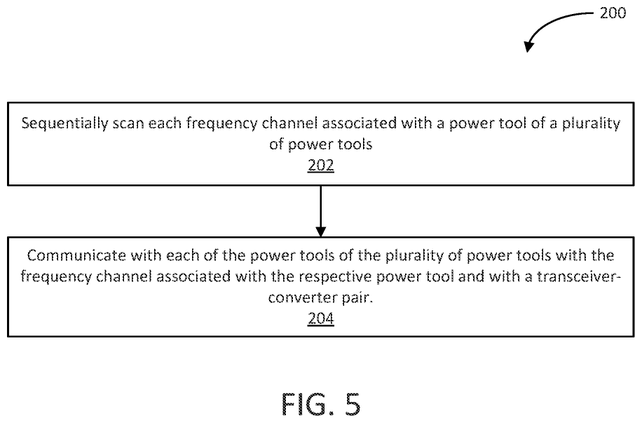

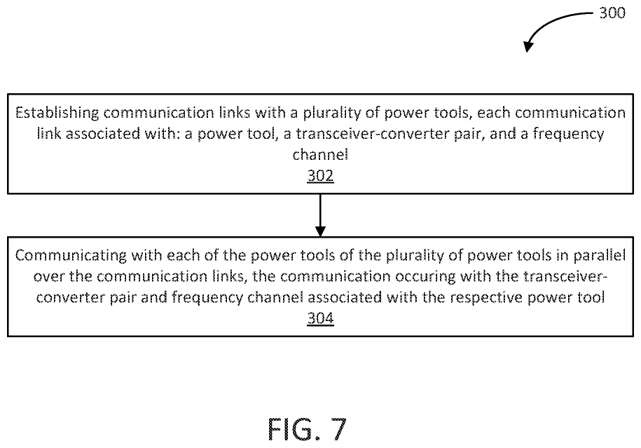

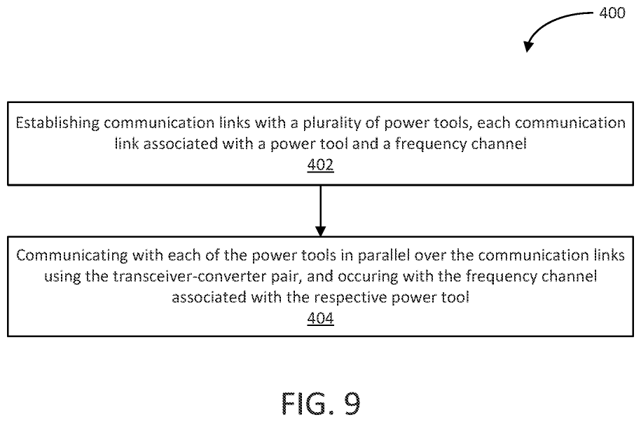

The electronic controller 140 is shown to include a processor 142 and a memory 144. The processor 142 can be implemented as a programmable processor, an application specific integrated circuit (ASIC), one or more field programmable gate arrays (FPGAs), a group of processing components, or other suitable electronic processing components. The memory 144 (e.g., memory, memory unit, storage device, etc.) can include one or more devices (e.g., RAM, ROM, Flash memory, hard disk storage, etc.) for storing data and/or computer code for completing or facilitating the various processes, layers and modules described herein. The memory 144 can be or include volatile memory or non-volatile memory. The memory 144 can include database components, object code components, script components, or any other type of information structure for supporting the various activities and information structures described in the present application. According to an example embodiment, the memory 144 is communicably connected to the processor 142 via a communication bus 143, which may be similar to the bus 130 of FIG. 2. The memory 144 can include instructions 145 for the processor 142 to execute. The processor 142 can be configured to communicate with the memory 144 to store data and retrieve stored data. The processor 142 can be configured to receive instructions and data from the memory 144 and execute, among other things, the instructions 145. For example, the processor 142 may retrieve and execute the instructions 145 stored in the memory 144. Thus, at least through execution of the instructions 145, the electronic controller 140 can be configured to control or perform the various functions of the gateway device 104 described herein, including performing one or more of the processes described herein (e.g., the process 200 of FIG. 5, the process 300 of FIG. 7, the process 400 of FIG. 9). The instructions 145 may include communication instructions (i.e., to enable the electronic controller 140 to communicate with power tools 102 and the network 106 via the communications interface 148). In some embodiments, the processor 142 includes one or more circuits or hardware elements to perform some or all of the functionality (or blocks of the processes 200, 300, 400), in place of or in addition to performing such functionally through execution of the instructions.

In some embodiments, the gateway device 104 can include a signal converter (e.g., within the communications interface 148, within the electronic controller 140, etc.) The signal converter can be configured to convert analog data to digital data, and vice versa. In some embodiments, the signal converter can include an analog-to-digital converter (ADC) and/or a digital-to-analog converter (DAC). An ADC may be specifically implemented to convert analog data to digital data (e.g., when data is received at the gateway device), in accordance with the present disclosure. A DAC may be specifically implemented to covert digital data to analog data (e.g., when data is to be transmitted from the gateway device), in accordance with the present disclosure.

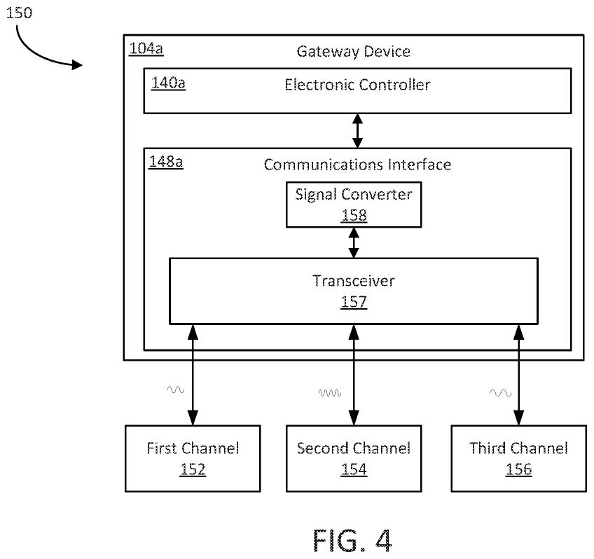

Referring now to FIG. 4, a block diagram illustrating a communication system 150 is shown, according to an example embodiment. The communication system 150 can include the gateway device 104a having an electronic controller 140a and a communication interface 148a. The gateway device 104a may be an example of the gateway device 104 described above, the electronic controller 140a may be an example of the electronic controller 140 described above, and the communication interface 148a may be an example of the communication interface 148 described above. Accordingly, the description provided herein with respect to the gateway device 104, the electronic controller 140, and the communication interface 148 similarly applies to the gateway device 104a, the electronic controller 140a, and the communication interface 148a, respectively. The gateway device 104a,can be configured to communicate with the power tool(s) 102 via a first channel 152, a second channel 154, and a third channel 156. Notably, the number of channels shown is not intended to be limiting: the communication system 150 can include fewer or additional channels, for example.

As shown, each channel (e.g., first channel 152, second channel 154, and third channel 156) can communicate with the communications interface 148a. In some embodiments, the communications interface 148a can include a transceiver 157 and a signal converter 158, which together may be referred to as a transceiver-converter pair. The transceiver 157 may include, for example, at least one antenna, at least one transmitter for driving the antenna with electrical signals to radiate or emit radio frequency (RF) signals, and at least one receiver for converting RF signals received by the antenna into electrical signals. The signal converter 158 can convert data when received from a channel and/or when transmitting via a channel. For example, the signal converter 158 may be a bidirectional analog-to-digital converter (e.g., in the form of an integrated circuit (IC)) that converts received analog data to digital data and that converts digital data to analog data for transmission. As used herein, analog data may include an analog signal encoding a digital data stream (e.g., generated by a power tool 102 or the gateway device 104). Additionally, the communications interface 148a can communicate with the electronic controller 140a.

In some embodiments, the communication system 150 can be configured to sequentially scan through the plurality of channels. As an example, the communications interface 148a may exclusively send and/or receive data via the first channel 152 for a predetermined period of time. Subsequently, the communications interface 148a may exclusively send and/or receive data via the second channel 154 for a predetermined period of time, etc. In some embodiments, upon scanning each of a plurality of channels, the gateway device 104a can be configured to restart the scanning sequence at the first channel (e.g., first channel 152). Each channel can be associated with a specific frequency (e.g., a known Bluetooth operating frequency). Each channel can also be associated with a particular power tool 102, at a given moment in time. Accordingly, each power tool can communicate with the gateway device 104a via a respective one of the channels at one of the specific frequencies. Using the communication system 150 and multiple communication channels, the gateway device 104a may more quickly communicate data with a plurality of power tools as compared to, for example, a gateway device that has a single channel. For example, in some embodiments, the communication system 150 can implement the process 200 as described with respect to FIG. 5.

Referring now to FIG. 5, a process 200 for parallel power tool communication is shown, in accordance with the present disclosure. The process 200 can be implemented using any of the systems described herein (e.g., the communication system 150). However, in some embodiments, the process 200 is implemented by another system having additional components, fewer components, alternative components, etc. In some specific cases, the process 200 can be implemented using a gateway device (e.g., the gateway device 104a). Additionally, although the blocks of the process 200 are illustrated in a particular order, in some embodiments, one or more of the blocks can be executed partially or entirely in parallel, can be executed in a different order than illustrated in FIG. 5, or can be bypassed. For illustration purposes, the process 200 is generally described as being implemented by the gateway device 104a in the context of the power tool system 100. However, in other embodiments, other devices or power tools of the power tool system 100, or other power tools or devices of other systems, may implement the process 200.

Block 202 of the process 200 can include the electronic controller 140a sequentially scanning, via a communication interface (e.g., the communications interface 148a), through a plurality of frequency channels (e.g., the first channel 152, the second channel 154, the third channel 156), each frequency channel associated with a power tool (e.g., power tools 102(a), 102(b), 102(c)) of a plurality of power tools. For example, the communications interface 148a may tune the transceiver 157 for reception of data and/or allot time for transmission of data via the first channel 152 for a predetermined period of time. Subsequently, the communications interface 148a may tune the transceiver 157 for reception of data and/or allot time for transmission of data via the second channel 154 for a predetermined period of time, and so on through each channel. In some embodiments, upon scanning each of a plurality of channels, the gateway device 104a can be configured to restart the scanning sequence at the first channel (e.g., first channel 152).

Block 204 of the process 200 can include the electronic controller 140a communicating, via the communication interface (e.g., the communications interface 148a), with each of the power tools (e.g., power tools 102(a), 102(b), 102(c)) of the plurality of power tools. The communication with each respective power tool of the plurality of power tools can occur with the frequency channel (e.g., the first channel 152, the second channel 154, or the third channel 156) associated with the respective power tool and with a transceiver-converter pair (e.g., the transceiver 157 and the signal converter 158). For example, as the electronic controller 140a sequentially scans through the plurality of frequency channels, during a time period allotted for each frequency channel, the electronic controller 140a may communicate (transmit and/or receive) data with a respective power tool 102 associated with that frequency channel. Accordingly, in some embodiments, execution of the blocks 202 and 204 may overlap. As an example, the electronic controller 140a, using the communications interface 148a, may momentarily transmit and/or receive data with the power tool 102a via the first channel 152, then momentarily transmit and/or receive data with the power tool 102b via the second channel 154, then momentarily transmit and/or receive data with the power tool 102c via the third channel 156, then again momentarily transmit and/or receive data with the power tool 102a via the first channel 152, and so on. Again, in some examples, the number of channels and power tools with which the electronic controller 140a may communicate when implementing the process 200 may vary and be less than or greater than three.

In some embodiments, the communication of block 204 may include the electronic controller 140a receiving data from each of the power tools (e.g., power tools 102(a), 102(b), 102(c)) sequentially, the data from each respective power tool of the power tools being received at the transceiver 157 of the transceiver-converter pair and in the frequency channel (e.g., the first channel 152, the second channel 154, or the third channel 156) associated with the respective power tool. The block 204 can further include converting from analog data to digital data at the signal converter (e.g., the signal converter 158) of the transceiver-converter pair.

In some embodiments, the communication of block 204 may include the electronic controller 140a transmitting data to each of the power tools (e.g., power tools 102(a), 102(b), 102(c)) sequentially, and converting the data to each respective power tool of the power tools from digital data to analog data at the signal converter (e.g., the signal converter 158) of the transceiver-converter pair. Additionally, the block 204 can include the electronic controller 140a transmitting, via the transceiver (e.g., via the communications interface 148a) of the transceiver-converter pair, in the frequency channel (e.g., first channel 152, second channel 154, third channel 156) associated with the respective power tool.

In some embodiments, the communication of block 204 can include the electronic controller 140a transmitting first data to at least a first power tool of the power tools (e.g., power tools 102(a), 102(b), 102(c)), and converting the first data from digital data to analog data at the signal converter (e.g., the signal converter 158) of the transceiver-converter pair. The process 200 can further include the electronic controller 140a transmitting, at the transceiver 157 of the transceiver-converter pair, in the frequency channel (e.g., the first channel 152) associated with the first power tool. Additionally, the communication of block 204 can include the electronic controller 140a receiving second data from a second power tool of the power tools, the second data being received at the transceiver 157 of the transceiver-converter pair and in the frequency channel associated with the second power tool (e.g., the second channel 154). The process 200 can further include converting from analog data to digital data at the signal converter (e.g., signal converter 158) of the transceiver-converter pair.

In some embodiments, the process 200 can include the electronic controller 140a transmitting or receiving, via the communication interface (e.g., the communications interface 148a), the data with a network (e.g., the network 106) using a network communication protocol that is different than a tool communication protocol used by the electronic controller (e.g., the electronic controller 140a) to communicate with the plurality of power tools. For example, as described above, the gateway 104a may receive data from one or more of the power tools 102 using a first protocol (e.g., Bluetooth® or Zigbee), and transmit that data to the server 108 via the network 106 using a second protocol (e.g., cellular or Wi-Fi®). As also described above, the gateway 104a may receive data from the server 108 via the network using the second protocol, and transmit that data on to one or more of the power tools 102 via the first protocol. In some examples, the gateway 104a includes a network transceiver for communicating with the network 106 that is different than the transceiver 157 used to communicate with the power tools 102.

In some embodiments, the data of process 200 can include one or more of status information for one or more of the plurality of power tools (e.g., the power tool 102(a), 102(b), 102(c)), tool operation data for one or more of the plurality of power tools, identification information for one or more of the plurality of power tools, power tool usage information for one or more of the plurality of power tools, power tool maintenance data for one or more of the plurality of power tools, or a software update for one or more of the plurality of power tools.

In some examples of the process 200, when sequentially scanning, the gateway device 104 may shift or tune to the next channel in the sequence after a predetermined amount of time. In some examples, when sequentially scanning, the gateway device 104 may shift or tune to the next channel in the sequence after (i) a predetermined amount of time and (ii) no messages incoming and/or outgoing occurring during the predetermined amount of time. For example, when tuned to a first channel, if an incoming message begins, the gateway device 104 may stay tuned to the first channel until completing receipt of the message or may otherwise delay tuning to the next channel in the sequence, rather than tuning to the next channel after the predetermined amount of time. Accordingly, in some examples of the process 200, while sequentially scanning (e.g., in block 202), the gateway device 104 may condition tuning to the next channel in the sequence on one or multiple conditions being satisfied.

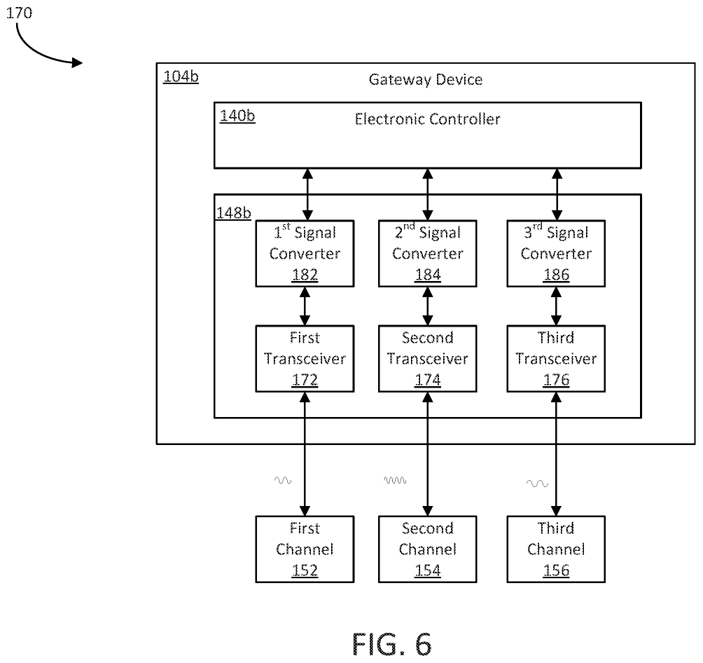

Referring now to FIG. 6, a block diagram illustrating a communication system 170 is shown, according to an example embodiment. The communication system 170 can include the gateway device 104b having an electronic controller 140b and a communication interface 148b. The gateway device 104b may be an example of the gateway device 104 described above, the electronic controller 140b may be an example of the electronic controller 140, and the communication interface 148b may be an example of the communication interface 148 described above. Accordingly, the description provided herein with respect to the gateway device 104, the electronic controller 140, and the communication interface 148 similarly applies to the gateway device 104b, electronic controller 140b, and the communication interface 148b, respectively. The gateway device 104b, which can be configured to communicate with the power tool(s) 102 via the first channel 152, the second channel 154, and the third channel 156. Notably, the number of channels shown is not intended to be limiting: the communication system 170 can include fewer or additional channels (and corresponding transceiver-converter pairs), for example.

As shown, each channel (e.g., first channel 152, second channel 154, third channel 156) can communicate with the communications interface 148b. In some embodiments, the communications interface 148b can include a plurality of transceiver-converter pairs, each pair including a transceiver and a signal converter. Each of a first signal converter 182, a second signal converter 184, and a third signal converter 186 can be configured to convert data when received from a corresponding channel and/or when transmitting via a corresponding channel. Each of the signal converters 182, 184, and 186 may, respectively, be similar to the signal converter 158. For example, each of the signal converters 182, 184, and 186, may be a bidirectional analog-to-digital converter (e.g., in the form of an integrated circuit (IC)) that converts received analog data to digital data and that converts digital data to analog data for transmission. The communication interface 148b may further include a first transceiver 172, a second transceiver 174, and a third transceiver 176. Similar to the transceiver 157 of FIG. 4, each transceiver 172, 174, and 176 may include at least one antenna, transmitter, and receiver.

The communication system 170 can be configured for parallel communication via the plurality of transceiver-converter pairs and associated frequency channels, according to some embodiments. As shown by FIG. 6, for example, the first transceiver 172 can be paired with the first signal converter 182, and the first transceiver 172 can be configured to exclusively transmit and receive data via the first channel 152. Similarly, the second transceiver 174 can be paired with the second signal converter 184, and the second transceiver 174 can be configured to exclusively transmit and receive data via the second channel 154. Still further, the third transceiver 176 can be paired with the third signal converter 186, and the third transceiver 176 can be configured to exclusively transmit and receive data via the third channel 156. As discussed above, each channel can be associated with a specific frequency (e.g., a known Bluetooth operating frequency). Additionally, each power tool can communicate with the gateway device 104b via one of the specific frequencies. Accordingly, within the communication system 170, the gateway device 104b can simultaneously (or otherwise in parallel) send and receive data from multiple power tools (i.e., via multiple channels). As used herein, two (or more) parallel communications may include communications that overlap in time, completely or in part. For example, a first communication on a first channel that starts and a second communication on a second channel starts before the first communication on the first channel ends, these communications may be considered to occur in parallel, regardless of whether the second communication ends before or after the first communication ends. Using the communication system 170 and parallel communication channels, the gateway device 104a may more quickly communicate data with a plurality of power tools as compared to, for example, a gateway device that has a single channel or, potentially, that cycles between channels. For example, in some embodiments, the communication system 170 can implement the process 300 as described with respect to FIG. 7.

Referring now to FIG. 7, a process 300 for parallel power tool communication is shown, in accordance with the present disclosure. The process 300 can be implemented using any of the systems described herein (e.g., the communication system 170). However, in some embodiments, the process 300 is implemented by another system having additional components, fewer components, alternative components, etc. In some specific cases, the process 300 can be implemented using a gateway device (e.g., the gateway device 104b). Additionally, although the blocks of the process 300 are illustrated in a particular order, in some embodiments, one or more of the blocks can be executed partially or entirely in parallel, can be executed in a different order than illustrated in FIG. 7, or can be bypassed. For illustration purposes, the process 300 is generally described as being implemented by the gateway device 104b in the context of the power tool system 100. However, in other embodiments, other devices or power tools of the power tool system 100, or other power tools or devices of other systems, may implement the process 300.

Block 302 of the process 300 can include the electronic controller 140b establishing, via a communication interface (e.g., the communications interface 148b), communication links with a plurality of power tools (e.g., power tools 102(a), 102(b), 102(c)), each communication link associated with a power tool of the plurality of power tools, with a transceiver-converter pair (e.g., first transceiver 172 and first signal converter 182, second transceiver 174 and second signal converter 184, or third transceiver 176 and third signal converter 186) of a plurality of transceiver-converter pairs of the communication interface, and with a frequency channel (e.g., first channel 152, second channel 154, or third channel 156) of a plurality of frequency channels. For example, the electronic controller 140b may receive an identifier of the power tool 102a via the first channel 152 and first transceiver 172, and may respond with a message via the first channel 152 to establish a first communication link. Similarly, the electronic controller 140b may receive an identifier of the power tool 102b via the second channel 154 and the second transceiver 174, and may respond via the second channel 154 with a message to establish a second communication link. Similarly, the electronic controller 140b may receive an identifier of the power tool 102c via the third channel 156 and the third transceiver 176, and may respond via the third channel 156 with a message to establish a third communication link. In some embodiments, the gateway device 104b initiates establishing the communication links, or another process for establishing communication links is implemented. As part of establishing the communication links, the electronic controller 140b may associate the identifier for each power tool 102a, 102b, and 102c with a respective frequency channel, for example, by storing or mapping (e.g., in a table of the memory 126) the identifier of each power tool 102a, 102b, and 102c with a channel identifier identifying the frequency channel associated with the particular power tool.

Block 304 of the process 300 can include the electronic controller 140b communicating, via the communication interface (e.g., the communications interface 148b), with each of the power tools (e.g., power tools 102(a), 102(b), 102(c)) of the plurality of power tools in parallel over the communication links, wherein the communication with each respective power tool of the plurality of power tools occurs with the transceiver-converter pair (e.g., first transceiver 172 and first signal converter 182, second transceiver 174 and second signal converter 184, third transceiver 176 and third signal converter 186) and frequency channel (e.g., first channel 152, second channel 154, third channel 156) associated with the respective power tool. As an example, the electronic controller 140b, using the communications interface 148b, may simultaneously (or otherwise in parallel) transmit and/or receive data with the power tool 102a via the first channel 152, first transceiver 172, and first signal converter 182, transmit and/or receive data with the power tool 102b via the second channel 154, the second transceiver 174, and the second signal converter 184, and transmit and/or receive data with the power tool 102c via the third channel 156, the third transceiver 176, and the third signal converter 178.

In some embodiments, the communication of block 304 can further include the electronic controller 140b receiving data from each of the power tools (e.g., power tools 102(a), 102(b), 102(c)) in parallel, the data from each respective power tool of the power tools being received at the transceiver (e.g., the first transceiver 172, the second transceiver 174, the third transceiver 176) of the transceiver-converter pair (e.g., first transceiver 172 and first signal converter 182, second transceiver 174 and second signal converter 184, third transceiver 176 and third signal converter 186) associated with the respective tool, and in the frequency channel (e.g., the first channel 152, the second channel 154, the third channel 156) associated with the respective tool. The block 304 can further include converting from analog data to digital data at the signal converter (e.g., the first signal converter 182, the second signal converter 184, the third signal converter 186) of the transceiver-converter pair associated with the respective power tool.

In some embodiments, the communication of block 304 can further include the electronic controller 140b transmitting data to each of the power tools (e.g., power tools 102(a), 102(b), 102(c)) in parallel, and converting the data to each respective power tool of the power tools from digital data to analog data at the signal converter (e.g., the first signal converter 182, the second signal converter 184, the third signal converter 186) of the transceiver-converter pair associated with the respective power tool. Additionally, the block 304 can include the electronic controller 140b transmitting, at the transceiver (e.g., via the communications interface 148b) of the transceiver-converter pair associated with the respective power tool, in the frequency channel (e.g., first channel 152, second channel 154, third channel 156) associated with the respective power tool.

In some embodiments, the communication of block 304 can include the electronic controller 140b transmitting first data to at least a first power tool of the power tools (e.g., power tools 102(a), 102(b), 102(c)), and converting the first data from digital data to analog data at the signal converter (e.g., the first signal converter 182, the second signal converter 184, the third signal converter 186) of the transceiver-converter pair (e.g., first transceiver 172 and first signal converter 182, second transceiver 174 and second signal converter 184, third transceiver 176 and third signal converter 186) associated with the first tool and in the frequency channel associated with the first tool. The block 304 can further include the electronic controller 140b transmitting, at the transceiver (e.g., the first transceiver 172, the second transceiver 174, the third transceiver 176) of the transceiver-converter pair (e.g., first transceiver 172 and first signal converter 182, second transceiver 174 and second signal converter 184, third transceiver 176 and third signal converter 186), in the frequency channel (e.g., first channel 152, second channel 154, third channel 156) associated with the first power tool. Additionally, the process 300 can include the electronic controller 140b receiving second data from a second power tool in parallel with the transmission of data to the first power tool, the second data being received at the transceiver of the transceiver-converter pair associated with the second power tool and in the frequency channel associated with the second power tool. The block 304 can further include converting from analog data to digital data at the signal converter (e.g., first signal converter 182, second signal converter 184, third signal converter 186) of the transceiver-converter pair associated with the second power tool.

In some embodiments, the process 300 can include the electronic controller 140b transmitting or receiving, via the communication interface (e.g., the communications interface 148b), the data with a network (e.g., the network 106) using a network communication protocol that is different than a tool communication protocol used by the electronic controller (e.g., the electronic controller 140b) to communicate with the plurality of power tools. For example, as described above, the gateway 104b may receive data from one or more of the power tools 102 using a first protocol (e.g., Bluetooth® or Zigbee), and transmit that data to the server 108 via the network 106 using a second protocol (e.g., cellular or Wi-Fi®). As also described above, the gateway 104b may receive data from the server 108 via the network using the second protocol, and transmit that data on to one or more of the power tools 102 via the first protocol. In some examples, the gateway 104b (e.g., as part of the communication interface 148b) includes a network transceiver for communicating with the network 106 that is different than the transceivers 172, 174, 176 used to communicate with the power tools 102.

In some embodiments, the data of process 300 can include one or more of status information for one or more of the plurality of power tools (e.g., the power tool 102(a), 102(b), 102(c)), tool operation data for one or more of the plurality of power tools, identification information for one or more of the plurality of power tools, power tool usage information for one or more of the plurality of power tools, power tool maintenance data for one or more of the plurality of power tools, or a software update for one or more of the plurality of power tools.

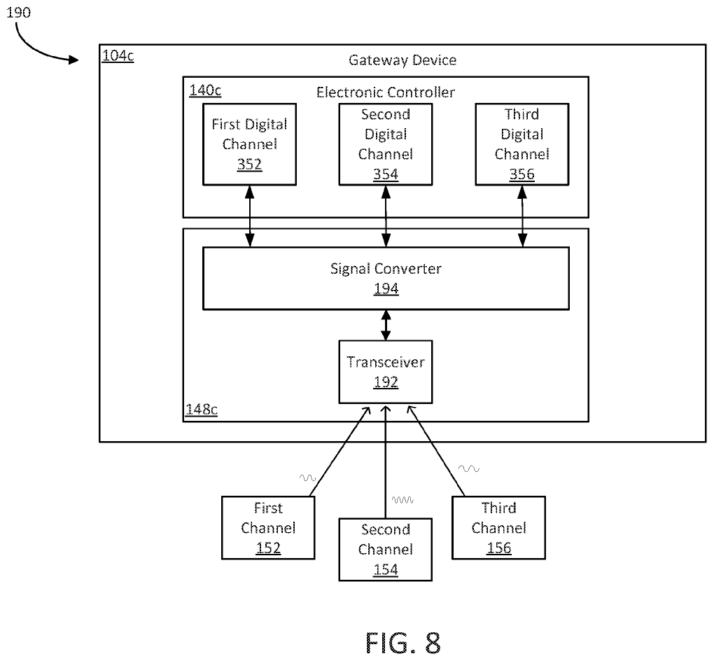

Referring now to FIG. 8, a block diagram illustrating a communication system 190 is shown, according to an example embodiment. The communication system 190 can include the gateway device 104c having an electronic controller 140c and a communication interface 148c. The gateway device 104c may be an example of the gateway device 104 described above, the electronic controller 140c may be an example of the electronic controller 140 described above, and the communication interface 148c may be an example of the communication interface 148 described above. Accordingly, the description provided herein with respect to the gateway device 104, the electronic controller 140, and the communication interface 148 similarly applies to the gateway device 104c, the electronic controller 140c, and the communication interface 148c, respectively. The gateway device 104c, which can be configured to communicate with the power tool(s) 102 via a plurality of frequencies associated with a transceiver 192 (e.g., via the first channel 152, the second channel 154, and the third channel 156). The transceiver 192 may include, for example, at least one antenna, transmitter, and receiver. The transceiver 192 can communicate with a signal converter 194. The signal converter 194 can be configured to convert data when received from a known frequency and/or when transmitting via a known frequency. In some embodiments, the communications interface 148c can implement a software defined radio (SDR) including the transceiver 192.

In some embodiments, the signal converter 194 may include a bidirectional analog-to-digital converter (e.g., in the form of an integrated circuit (IC)) that converts received analog data to digital data and that converts digital data to analog data for transmission. In some embodiments, the signal converter 194 can be further configured to split or separate received digital data (e.g., output by the analog-to-digital converter) into respective digital data channels (e.g., first digital channel 352, second digital channel 354, third digital channel 356). For example, the signal converter 194 may further include processing circuitry and/or software configure to split or separate the digital data. This further processing circuitry and/or software may implement a demultiplexer for frequency-division multiplexing (FDM) to split the received digital data into respective digital data channels. For example, the demultiplexer may include one or more bandpass filters to split the digital data into the various channels. Additionally, the signal converter 194 can be further configured to combine digital data received via respective digital data channels (e.g., first digital channel 352, second digital channel 354, third digital channel 356) to be transmitted by the gateway device 104. For example, the signal converter 194 may further include processing circuitry and/or software configure to combine the digital data. This further processing circuitry and/or software may implement a multiplexer for frequency-division multiplexing (FDM) to combine or sum the received digital data into respective digital data channels. The signal converter 194, or a portion thereof (e.g., a portion that performs the separation of the digital data into respective channels) may be implemented in an ASIC, FGPA, or processor executing digital signal processing software. Each digital data channel can correspond to a specific frequency (e.g., a known Bluetooth operating frequency) associated with the transceiver 192. For example, the first digital channel 352 may correspond to the first channel 152, the second digital channel 354 may correspond to the second channel 154, and the third digital channel 356 may correspond to the third channel 156. Although the digital data channels 352, 354, and 356 are illustrated as being in the electronic controller 140c, the channels may also be considered as part of the signal converter 194 and/or the connection between the signal converter 194 and the electronic controller 140c. The transceiver 192 can be configured to receive or transmit using multiple frequencies, simultaneously. Additionally, each power tool can communicate with the gateway device 104 via one of the specific frequencies. Accordingly, within the communication system 190, the gateway device 104 can simultaneously (or otherwise in parallel) send and receive data from multiple power tools (i.e., via a single transceiver). Using the communication system 190 and parallel communication channels, the gateway device 104c may more quickly communicate data with a plurality of power tools as compared to, for example, a gateway device that has a single channel or, potentially, that cycles between channels. Additionally, relative to the gateway device 104b of FIG. 6, the gateway device 104c includes a communication interface 148c with fewer components (e.g., converters and transceivers). In some embodiments, the communication system 190 can implement the process 400 as described with respect to FIG. 9.

Referring now to FIG. 9, a process 400 for power tool communication is shown, in accordance with the present disclosure. The process 400 can be implemented using any of the systems described herein (e.g., the communication system 190). However, in some embodiments, the process 400 is implemented by another system having additional components, fewer components, alternative components, etc. In some specific cases, the process 400 can be implemented using a gateway device (e.g., the gateway device 104). Additionally, although the blocks of the process 400 are illustrated in a particular order, in some embodiments, one or more of the blocks can be executed partially or entirely in parallel, can be executed in a different order than illustrated in FIG. 9, or can be bypassed. For illustration purposes, the process 400 is generally described as being implemented by the gateway device 104 in the context of the power tool system 100. However, in other embodiments, other devices or power tools of the power tool system 100, or other power tools or devices of other systems, may implement the process 400.

Block 402 of the process 400 can include the electronic controller 140c establishing, via a communication interface (e.g., communications interface 148), communication links with a plurality of power tools (e.g., power tools 102(a), 102(b), 102(c)), each communication link associated with a power tool of the plurality of power tools and with a frequency channel (e.g., the first channel 152, the second channel 154, the third channel 156) of a plurality of frequency channels. For example, the electronic controller 140c may receive an identifier of the power tool 102a via the first channel 152. the transceiver 192, the signal converter 194, and the first digital channel 352, and may respond with a message via the first channel 152, the transceiver 192, the signal converter 194, and the first digital channel 352 to establish a first communication link. Similarly, the electronic controller 140c may receive an identifier of the power tool 102b via the second channel 154, the transceiver 192, the signal converter 194, and the second digital channel 354, and may respond via the second channel 154, the transceiver 192, the signal converter 194, and the second digital channel 354 with a message to establish a second communication link. Similarly, the electronic controller 140c may receive an identifier of the power tool 102c via the third channel 156, the transceiver 192, the signal converter 194, and the third digital channel 356, and may respond via the third channel 156, the transceiver 192, the signal converter 194, and the third digital channel 356 with a message to establish a third communication link. In some embodiments, the gateway device 104 initiates establishing the communication links, or another process for establishing communication links is implemented. As part of establishing the communication links, the electronic controller 140c may associate the identifier for each power tool 102a, 102b, and 102c with a respective frequency channel 152, 154, and 156 (and/or a digital channel 352, 354, and 356), for example, by storing or mapping (e.g., in a table of the memory 126) the identifier of each power tool 102a, 102b, and 102c with a channel identifier identifying the frequency channel associated with the particular power tool.

Block 404 of the process 400 can include the electronic controller 140c communicating, via the communication interface (e.g., communications interface 148), with each of the power tools (e.g., power tools 102(a), 102(b), 102(c)) of the plurality of power tools in parallel over the communication links using the transceiver-converter pair (e.g., transceiver 192 and signal converter 194), wherein the communication with each respective power tool of the plurality of power tools occurs with the frequency channel (e.g., the first channel 152, the second channel 154, the third channel 156) associated with the respective power tool. As an example, the electronic controller 140c, using the communications interface 148, may simultaneously (or otherwise in parallel) transmit and/or receive data with the power tool 102a via the first channel 152, the transceiver 192, the signal converter 194, and the first digital channel 352: transmit and/or receive data with the power tool 102b via the second channel 154, the transceiver 192, the signal converter 194, and the second digital channel 354; and transmit and/or receive data with the power tool 102c via the third channel 156, the transceiver 192, the signal converter 194, and the third digital channel 356.

In some embodiments, the communication of block 404 can include receiving analog data, from the plurality of power tools (e.g., power tools 102(a), 102(b), 102(c)) in parallel, at the transceiver (e.g., transceiver 192) of the transceiver-converter pair (e.g., transceiver 192 and signal converter 194) and across the plurality of frequency channels (e.g., the first channel 152, the second channel 154, the third channel 156). The block 404 can further include converting the analog data to digital data at the signal converter (e.g., the signal converter 194) of the transceiver-converter pair. Additionally, the communication of block 404 can include processing the digital data to split the digital data into respective digital data channels (e.g., first digital channel 352, second digital channel 354, third digital channel 356), each digital data channel corresponding to a frequency channel of the plurality of frequency channels.

In some embodiments, the communication of block 404 can include combining digital data from digital data channels into combined digital data, each digital data channel corresponding to a frequency channel of the plurality of frequency channels. This combining may be performed by the signal converter 194, using similar (but opposite or reciprocal) techniques as described above with respect to splitting the digital signal into respective digital channels. The block 404 can further include converting the combined digital data to analog data at the signal converter of the transceiver-converter pair (e.g., the transceiver 192 and signal converter 194). Additionally, the block 404 can include transmitting the analog data via the transceiver (e.g., the transceiver 192) of the transceiver-converter pair across the plurality of frequency channels.

In some embodiments, the process 400 can include the electronic controller 140c transmitting or receiving, via the communication interface (e.g., the communications interface 148), the data with a network (e.g., the network 106) using a network communication protocol that is different than a tool communication protocol used by the electronic controller (e.g., the electronic controller 140c) to communicate with the plurality of power tools. For example, as described above, the gateway 104 may receive data from one or more of the power tools 102 using a first protocol (e.g., Bluetooth® or Zigbee), and transmit that data to the server 108 via the network 106 using a second protocol (e.g., cellular or Wi-Fi®). As also described above, the gateway 104 may receive data from the server 108 via the network using the second protocol, and transmit that data on to one or more of the power tools 102 via the first protocol. In some examples, the gateway 104 (e.g., the communications interface 148) includes a network transceiver for communicating with the network 106 that is different than the transceiver 192 used to communicate with the power tools 102.

In some embodiments, the data of process 400 can include one or more of status information for one or more of the plurality of power tools (e.g., the power tool 102(a), 102(b), 102(c)), tool operation data for one or more of the plurality of power tools, identification information for one or more of the plurality of power tools, power tool usage information for one or more of the plurality of power tools, power tool maintenance data for one or more of the plurality of power tools, or software update for one or more of the plurality of power tools.

It is to be understood that, although the various signal converters herein (e.g., signal converter 158, first signal converter 182, second signal converter 184, third signal converter 186, signal converter 194) are shown and described as a component within the communications interface (e.g., the communications interface 148), one or more signal converters may be a component within the electronic controller (e.g., the electronic controller 140c), or the gateway device more broadly (e.g., the gateway device 104). In this case, the communications interface can include some components that may be part of the electronic controller, and some components that may not be part of the electronic controller.

While the disclosure has been mainly framed around a gateway device communication with power tools, it is also contemplated that the embodiments of the disclosure can be applied to communication with tools in general (e.g., both powered and non-powered tools), to power tool battery packs, and to power tool accessories. For example, the power tool system 100 may include one or more non-powered tools (e.g., a wrench, a screwdriver, a ratchet, other hand tools, etc.) or power tool accessories (e.g., toolboxes or other tool storage containers, personal protective equipment (e.g., work gloves, masks, protective eyewear or glasses, pads, helmets, and protective apparel)) that have attached thereto a power source (e.g., a battery) and a communication system. The communication system may include an electronic controller (similar to electronic controller 122) and a transceiver (similar to transceiver 136) to facilitate communication with other devices of the power tool system 100 (e.g., the gateway device 104 and power tools). In a specific case, the power source and the communication system can be coupled to a housing of a non-powered tool or power tool accessory or can be located within the housing of the non-powered tool (e.g., within the handle of the non-powered tool) or power tool accessory. Additionally, the gateway device 104 may communicate with power tool battery packs that have transceivers (e.g., as described above with respect to some examples of the power source 134 of FIG. 2), in a similar manner as the gateway device 104 is described as communication with power tools. Accordingly, a gateway device (e.g., the gateway device 104) or other device implementing the processes 200, 300, and 400 may similarly communicate with such non-powered tools, power tool battery packs, and/or power tool accessories instead of or in addition to power tools. The term power tool device may be used to refer to a power tool (e.g., the power tool 102), whether motorized or non-motorized, and/or to refer to a power tool battery pack (e.g., serving as the power source 134) that can attach to and power a power tool. Accordingly, in some embodiments, the gateway device 104 may perform the process 200, 300, and/or 400 with respect to power tool device communications.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including.” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature can sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components can be consolidated and performed by a single component. Similarly, the functions described herein as being performed by one component can be performed by multiple components in a distributed manner. Additionally, a component described as performing particular functionality can also perform additional functionality not described herein. For example, a device or structure that is “configured” in a certain way is configured in at least that way, but can also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications can be made to these configurations without departing from the scope or spirit of the claimed subject matter.

Certain operations of methods according to the disclosure, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component.” “system,” “module,” etc. are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions can be used to discuss aspects of a particular example or figure, but do not necessarily require similar orientation or geometry in all installations or configurations.

As used herein, unless otherwise defined or limited, the phase “and/or” used with two or more items is intended to cover the items individually and the items together. For example, a device having “a and/or b” is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A gateway device for communication with power tool devices, the gateway device comprising:
a communications interface including a transceiver-converter pair, the transceiver-converter pair including a transceiver coupled to a signal converter; and
an electronic controller coupled to the communications interface and including a processor, the electronic controller configured to:
sequentially scan, via the communication interface, through a plurality of frequency channels, each frequency channel associated with a power tool device of a plurality of power tool devices; and
communicate, via the communication interface, data with each of the power tool devices of the plurality of power tool devices, wherein the communication with each respective power tool device of the plurality of power tool devices occurs with the frequency channel associated with the respective power tool device and with the transceiver-converter pair.

2. The gateway device of claim 1, wherein, to communicate, via the communication interface, data with each of the power tool devices of the plurality of power tool devices, the electronic controller is further configured to:
receive the data from each of the power tool devices sequentially, the data from each respective power tool device of the power tool devices being
received at the transceiver of the transceiver-converter pair and in the frequency channel associated with the respective power tool device, and
converted from analog data to digital data at the signal converter of the transceiver-converter pair associated with the respective power tool device.

3. The gateway device of claim 1, wherein, to communicate, via the communication interface, data with each of the power tool devices of the plurality of power tool devices, the electronic controller is further configured to:
transmit the data to each of the power tool devices sequentially, the data to each respective power tool device of the power tool devices being
converted from digital data to analog data at the signal converter of the transceiver-converter pair, and
transmitted, at the transceiver of the transceiver-converter pair, in the frequency channel associated with the respective power tool device.

4. The gateway device of claim 1, wherein, to communicate, via the communication interface, data with each of the power tool devices of the plurality of power tool devices, the electronic controller is further configured to:
transmit first data of the data to at least a first power tool device of the power tool devices, the first data being
converted from digital data to analog data at the signal converter of the transceiver-converter pair, and
transmitted, at the transceiver of the transceiver-converter pair, in the frequency channel associated with the first power tool device; and
receive second data of the data from a second power tool device of the power tool devices, the second data being
received at the transceiver of the transceiver-converter pair and in the frequency channel associated with the second power tool device, and
converted from analog data to digital data at the signal converter of the transceiver-converter pair.

5. The gateway device of claim 1, wherein the electronic controller is further configured to:
transmit or receive, via the communication interface, the data with a network using a network communication protocol that is different than a tool communication protocol used by the electronic controller to communicate with the plurality of power tool devices.

6. The gateway device of claim 1, wherein the data includes one or more of status information for one or more of the plurality of power tool devices, tool operation data for one or more of the plurality of power tool devices, identification information for one or more of the plurality of power tool devices, power tool device usage information for one or more of the plurality of power tool devices, power tool device maintenance data for one or more of the plurality of power tool devices, or a software update for one or more of the plurality of power tool devices.

7. The gateway device of claim 1, the electronic controller further configured to:
sequentially scan, via the communication interface, through additional frequency channels in addition to the plurality of frequency channels, each additional frequency channel associated with a non-powered tool or power tool accessory; and
communicate, via the communication interface, additional data with each non-powered tool or power tool accessory, wherein the communication with each respective non-powered tool or power tool accessory occurs with the additional frequency channel associated with the respective non-powered tool or power tool accessory and with an additional transceiver-converter pair of the communication interface.

8. A gateway device for parallel communication with power tool devices, the gateway device comprising:
a communications interface including a plurality of transceiver-converter pairs, each transceiver-converter pair including a transceiver coupled to a signal converter; and
an electronic controller coupled to the communications interface and including a processor, the electronic controller configured to:
establish, via the communication interface, communication links with a plurality of power tool devices, each communication link associated with a power tool device of the plurality of power tool devices, with a transceiver-converter pair of the plurality of transceiver-converter pairs, and with a frequency channel of a plurality of frequency channels; and
communicate, via the communication interface, data with each of the power tool devices of the plurality of power tool devices in parallel over the communication links, wherein the communication with each respective power tool device of the plurality of power tool devices occurs with the transceiver-converter pair and frequency channel associated with the respective power tool device.

9. The gateway device of claim 8, wherein, to communicate, via the communication interface, data with each of the power tool devices of the plurality of power tool devices in parallel over the communication links, the electronic controller is further configured to:
receive the data from each of the power tool devices in parallel, the data from each respective power tool device of the power tool devices being
received at the transceiver of the transceiver-converter pair associated with the respective tool and in the frequency channel associated with the respective tool, and
converted from analog data to digital data at the signal converter of the transceiver-converter pair associated with the respective tool.

10. The gateway device of claim 8, wherein, to communicate, via the communication interface, data with each of the power tool devices of the plurality of power tool devices in parallel over the communication links, the electronic controller is further configured to:
transmit the data to each of the power tool devices in parallel, the data to each respective power tool device of the power tool devices being
converted from digital data to analog data at the signal converter of the transceiver-converter pair associated with the respective power tool device, and
transmitted at the transceiver of the transceiver-converter pair associated with the respective tool and in the frequency channel associated with the respective power tool device.

11. The gateway device of claim 8, wherein, to communicate, via the communication interface, data with each of the power tool devices of the plurality of power tool devices in parallel over the communication links, the electronic controller is further configured to:
transmit first data of the data to at least a first power tool device of the power tool devices, the first data being
converted from digital data to analog data at the signal converter of the transceiver-converter pair associated with the first power tool device, and
transmitted at the transceiver of the transceiver-converter pair associated with the first power tool device and in the frequency channel associated with the first power tool device; and
receive second data of the data from a second power tool device in parallel with the transmission of the first data to the first power tool device, the second data being
received at the transceiver of the transceiver-converter pair associated with the second power tool device and in the frequency channel associated with the second power tool device, and
converted from analog data to digital data at the signal converter of the transceiver-converter pair associated with the second power tool device.

12. The gateway device of claim 8, wherein the electronic controller is further configured to:
transmit or receive, via the communication interface, the data with a network using a network communication protocol that is different than a tool communication protocol used by the electronic controller to communicate with the plurality of power tool devices.

13. The gateway device of claim 8, wherein the data includes one or more of status information for one or more of the plurality of power tool devices, tool operation data for one or more of the plurality of power tool devices, identification information for one or more of the plurality of power tool devices, power tool device usage information for one or more of the plurality of power tool devices, power tool device maintenance data for one or more of the plurality of power tool devices, or a software update for one or more of the plurality of power tool devices.

14. The gateway device of claim 8, the electronic controller further configured to:
establish, via the communication interface, an additional communication link with a non-powered tool or power tool accessory, the additional communication link associated with the non-powered tool or power tool accessory, with an additional transceiver-converter pair of the plurality of transceiver-converter pairs, and with an additional frequency channel of a plurality of frequency channels; and
communicate, via the communication interface, additional data with the non-powered tool or power tool accessory over the additional communication link in parallel with the data communicated over the communication links, wherein the communication with the non-powered tool or power tool accessory occurs with the additional transceiver-converter pair and the additional frequency channel associated with the non-powered tool or power tool accessory.

15. A gateway device for parallel communication with power tool devices, the gateway device comprising:
a communications interface including a transceiver-converter pair, the transceiver-converter pair including a transceiver coupled to a signal converter; and
an electronic controller coupled to the communications interface and including a processor, the electronic controller configured to:
establish, via the communication interface, communication links with a plurality of power tool devices, each communication link associated with a power tool device of the plurality of power tool devices and with a frequency channel of a plurality of frequency channels; and
communicate, via the communication interface, data with each of the power tool devices of the plurality of power tool devices in parallel over the communication links using the transceiver-converter pair, wherein the communication with each respective power tool device of the plurality of power tool devices occurs with the frequency channel associated with the respective power tool device.

16.-40. (canceled)
